(19) United States
(12) Patent Application Publication
(10) Pub. No.: US 2012/0006907 A1
(43) Pub. Date: Jan. 12, 2012

(54) SENSOR ARRANGEMENT FOR ACQUIRING STATE VARIABLES

(76) Inventors: Thomas Niemann, Delmenhorst (DE); Olaf Lüdtke, Vollersode (DE); Almut Schlarmann, Bremen (DE); Jürgen Palloks, Westerstede (DE); Antje Müller, Lilienthal (DE); Tim Petasch, Bremen (DE)

(21) Appl. No.: 13/177,211

(22) Filed: Jul. 6, 2011

(30) Foreign Application Priority Data
Jul. 8, 2010 (DE) 102010026563.2

(51) Int. Cl. G05D 22/02; G01N 19/10

(52) U.S. Cl. 236/44 C; 73/29.02

(57) ABSTRACT

The invention relates to a device for acquiring predetermined state variables inside a room, in particular in the interior of a motor vehicle, with at least one temperature sensor and with a humidity sensor, at least regions of which are enclosed by a housing, wherein a first temperature sensor exhibits at least one contact surface for abutting against a perimeter surface bordering the room, and that at least one second temperature sensor is provided inside the housing for acquiring the room temperature. The contact surface is thereby a surface piece of a printed circuit board section of a printed circuit board, which encompasses elastic characteristics, wherein the printed circuit board section encompasses a plurality of surface pieces, which are angled relative to one another, and the temperature sensors are arranged at different surface pieces.

The invention relates to a device for acquiring predetermined state variables inside a room, in particular in the interior of a motor vehicle, with at least one temperature sensor and with a humidity sensor, at least regions of which are enclosed by a housing, wherein the first temperature sensor exhibits at least one contact surface for abutting against a perimeter surface bordering the room, and that at least one second temperature sensor is provided inside the housing for acquiring the room temperature.

Known generic devices encompass specific sensor arrangements, and are used to acquire state variables, with which conclusions about prevailing environmental conditions can be drawn, for example in a greenhouse or the interior of a motor vehicle. The state variables, for example temperature or air humidity, are here recorded inside the room by means of the sensor arrangement, especially in a continuous manner, after which electrical signals are relayed, for example, to a control unit of an air-conditioning system as a function of the intensity or magnitude of the recorded state variables. The air-conditioning system can then be used in turn to influence the state variables in the room, until the monitored state variables have been adjusted to the environmental conditions desired at the application site.

Known from EP 1 598 224 A1, for example, is a device for determining fog on the inside of a surface in the interior of a motor vehicle, such as a front window. The device is used to measure the windowpane temperature and relative air humidity in the interior of the vehicle. These measured values here serve to determine the dew point, meaning the temperature at which the room air can absorb no more water, so that condensation occurs, especially on the inside of the surface. Predominantly a thermal linkage of the humidity sensor takes place by way of the conductors, which are used simultaneously for purposes of electrical contacting and vapor deposited in particular on the surface to be analyzed.

In addition to a humidity sensor, known devices for determining state variables exhibit at least one temperature sensor, wherein at least sections of the latter are enclosed by a housing. As a rule, the devices or sensor arrangements are equipped with a temperature sensor, the temperature detector of which is routed toward the outside, meaning outside of the housing. The temperature detector can then be used among other things to determine the temperature on the wall surface bordering the room, for example on the inside of a windowpane. By contrast, the room temperature is frequently acquired with individually arranged temperature sensors, which are situated at whatever location or position within the room, and separately connected with a control unit of an air-conditioning system so as to transfer data.

By contrast, an electronic device for detecting room climate data, which comprises a temperature measuring device and a humidity measuring device, is known from DE 10 2008 029 145 A1. The temperature measuring device encompasses a first temperature sensor for measuring the wall temperature and a second temperature sensor for detecting the room temperature. The temperature sensors are in each case arranged on housing walls of the device, which are arranged opposite one another, so as to be spaced apart from one another as far as possible, which results in an extensive wiring within the device. The humidity measuring device thereby encompasses a humidity sensor for measuring the humidity, which is also arranged so as to be spaced apart from the room wall. As a result, the structural configuration of the known devices is relatively complex, and it is always a complicated process to realize a connection between the sensors recording the state variables and a control unit acquiring the output signal.

Therefore, the object of the invention is to create a device for acquiring state variables that enables a simplified and simultaneously reliable acquisition of the relevant state variables.

The object is achieved according to the invention by a device with the features in claim 1. Advantageous further developments and embodiments of the invention are indicated in claims 2 to 11.

In a device for acquiring predetermined state variables inside a room, in particular within the interior of a motor vehicle, with at least one temperature sensor and a humidity sensor, at least sections of which are encompassed by a housing, wherein a first temperature sensor exhibits at least one contact surface for abutting against a perimeter surface bordering the room, and that at least one second temperature sensor is provided inside the housing for acquiring the room temperature, the invention provides that the contact surface is a surface piece of a printed circuit board section of a printed circuit board, which encompasses elastic characteristics, and that the printed circuit board section encompasses a plurality of surface pieces, which are angled relative to one another, wherein the temperature sensors are arranged at different surfaces pieces of the printed circuit board section.

Such a device according to the invention or such a sensor arrangement according to the invention within a housing that incorporates at least sections of the various sensors ensures an advantageously easy and reliable way of acquiring the required state variables within a room, and transferring the signals output by the sensors, for example to a control unit. Such a compactly designed sensor arrangement can always be used to reliably acquire both the room temperature and the temperature of the wall surface bordering the room along with air humidity in the room at the same time, so that, for example, a control unit of an air-conditioning system of a greenhouse is actuated from only a single detection device. By positioning the sensors at or on a printed circuit board section, respectively, with advantageously small distances relative to one another, a housing comprising relatively small dimensions can then be used. The contact surface is thereby preferably a surface piece of a printed circuit board section of a printed circuit board, which encompasses elastic characteristics, in the case of which an advantageously safe attachment of the contact surface of the contact temperature sensor to the inner side of the boundary surface for a room, which is embodied as a window pane, for example, can be ensured. Provision is thus made between the contact surface of the contact temperature sensor and the inner side of the boundary surfaces for a transfer means, namely a surface piece of the printed circuit board itself, which is then made of an advantageously heat-conducting material. Likewise, it is also possible for the contact surface of the temperature sensor to rest directly against the inner side of the window pane. The surface pieces of the printed circuit board section are thereby angled relative to one another, in particular they are arranged at a right angle to one another, whereby the second temperature sensor, which detects the room temperature, encompasses a relatively small, but sufficient distance to the first temperature sensor. An impact on the second temperature sensor with reference to its measuring values, which are to be detected, must not be expected through this. Due to the surfaces, which are angled relative to one another, the printed circuit board section additionally encompasses advantageously reduced dimensions, so that the device according to the invention requires a relatively small cross section. The printed circuit board section exhibiting resilient or flexible properties can here preferably be annular in design, with at least one partial segment that runs into a plane.

A further development of the invention provides that the contact surface of the first temperature sensor projects over an opening in the outer contour of the housing. The formation of an opening or recess in predetermined areas of the housing wall represents a structurally easy way to bring at least a partial area or section of the touch temperature sensor, in particular its temperature-sensitive contact surface, into contact with the inside of a wall surface bordering the room. The contact surface of the touch temperature sensor here preferably protrudes on the outer contour of the housing incorporating the temperature sensor in the area of two housing sections adjoining each other, and is brought into contact in particular with a windowpane of the room to be air conditioned. A change in the environmental conditions prevailing outside the room, such as precipitation or strong sunlight, can always be relatively easily, and hence reliably, acquired by way of a windowpane, so that conclusions can be drawn about the air humidity content that changes as a function of the above. This advantageously makes it possible to keep the air humidity content inside the room constant by correspondingly regulating the air-conditioning system.

In addition, the housing exhibits passage openings for an air stream passed through the housing, which incorporate at least one of the temperature sensors. In particular during precipitation, which normally causes the temperature acquired on the periphery surface to drop relatively quickly, while the air humidity content simultaneously rises, the passage openings provided in the housing can be used to generate a directed or guided air stream through the device. As a result, an environmental temperature sensor arranged inside the housing for acquiring the room temperature can be exposed directly to a stream of fresh air output by an air-conditioning system, so that a resultant temperature change is acquired relatively soon. Distorted measured values owing to a temperature buildup in the housing, and hence acquired values that deviate from the actual value that is really present, are advantageously prevented.

Preferably, the printed circuit board section is embodied as channel piece for the air stream, which is guided through the housing, whereby it is ensured that the room air is guided directly past at least the temperature sensor, which records the room temperature. With reference to this, the temperature sensors and the humidity sensor are arranged at the inner sides of the surface pieces, which embody the printed circuit board section, which ensures the contact with the air stream, which is guided through the device, in a reliable manner.

As an alternative or option, a further development of the invention provides that the housing exhibits passage openings for an air stream guided through the housing, which incorporates at least the humidity sensor. The advantage to arranging the humidity sensor inside the air stream guided through the housing is also that a representative measurement can here be made of the air humidity content of the air blown directly into the room. This in turn enables a regulation of the air humidity content in the room with an advantageous slight delay by means of an air-conditioning system. The air stream guided through the housing can here be routed via the annularly designed section of the printed circuit board from a passage designed as an inlet opening to a second passage in the housing designed as an outlet opening.

At least one of the temperature sensors is preferably an NTC resistor, the use of which offers an advantageously easy way to acquire the room temperature or temperature on the inside of the wall surface bordering the room, for example. The NTC resistors, also referred to as NTC thermistors, are fabricated using semiconductor materials or other alloys with negative temperature coefficients, for example, which conduct currents better at relatively high temperatures than at low temperatures. Therefore, a change in the acquired state variables always results in a direct change in the output signals output by the environmental temperature sensor for acquiring the room temperature or by the touch temperature sensor, for example. NTC resistors can here be used in a measuring range of between −80° C. and 250° C., which always ensures the smooth acquisition of state variables that are naturally established.

Of course, it is within the framework of the invention that at least one of the temperature sensors be designed as a thermopile for contactless temperature measurement. In particular a defined interior region is here scanned, for example the surface of an object in the infrared spectral range. The thermal radiation emitted by the scanned area is acquired by the environmental temperature sensor, for example designed as a thermopile, and converted into a preferably electrical output signal. Therefore, the advantage to using a thermopile is that the room temperature can advantageously be specifically acquired outside the housing of the device according to the invention. A change in room temperature is then acquired with a delay if needed, since the body temperature of the scanned object must first adjust to the changed air temperature.

In addition to the temperature sensors and humidity sensor, the housing preferably accommodates at least one solar sensor, with which the sunlight is advantageously acquired, and conclusions can be drawn about the solar load incident or acting on the room, and an increase in room temperature associated therewith. By acquiring the intensity of sunlight, wherein it is acquired in particular in a region translucent to visible light, in particular a windowpane, of a wall surface bordering the room, a control unit of the air-conditioning system coupled with the device can be used to counter at an early point the state variables, which are changing due to an elevated solar load, for example the interior temperature.

Another further development of the invention provides for a rain sensor in addition to the temperature sensors and humidity sensor, which especially when combined with the touch temperature sensor preferably arranged on the inside of a windowpane can detect possible precipitation early on the one hand, and reliably on the other.

In a motor vehicle with at least one device for acquiring predetermined state variables, which is coupled with at least one control unit of an air-conditioning system for air-conditioning the vehicle interior, for which independent patent protection is being sought, the invention provides that the device be designed according to one of claims 1 to 9.

Such a device according to the invention for acquiring relevant state variables in the vehicle interior can be used to advantageously control or regulate the air-conditioning system of the vehicle, so that comfortable and climatic conditions can always be established for individuals inside the vehicle. This makes it possible to take appropriate early countermeasures to deal with the potential changing influences that can correspondingly be reliably detected, so that the state variables inside the motor vehicle can always be kept relatively stable, regardless of the environmental conditions outside of the vehicle.

The device is preferably allocated to the front window of the vehicle, in particular the inside thereof, which represents an optimal way of arranging the device according to the invention within the motor vehicle. The front window of the vehicle makes it possible to easily, and hence reliably, acquire or detect specific influences, such as precipitation or sunlight incident on the vehicle.

The drawing depicts one possible exemplary embodiment of the invention associated with additional inventive features. Shown on:

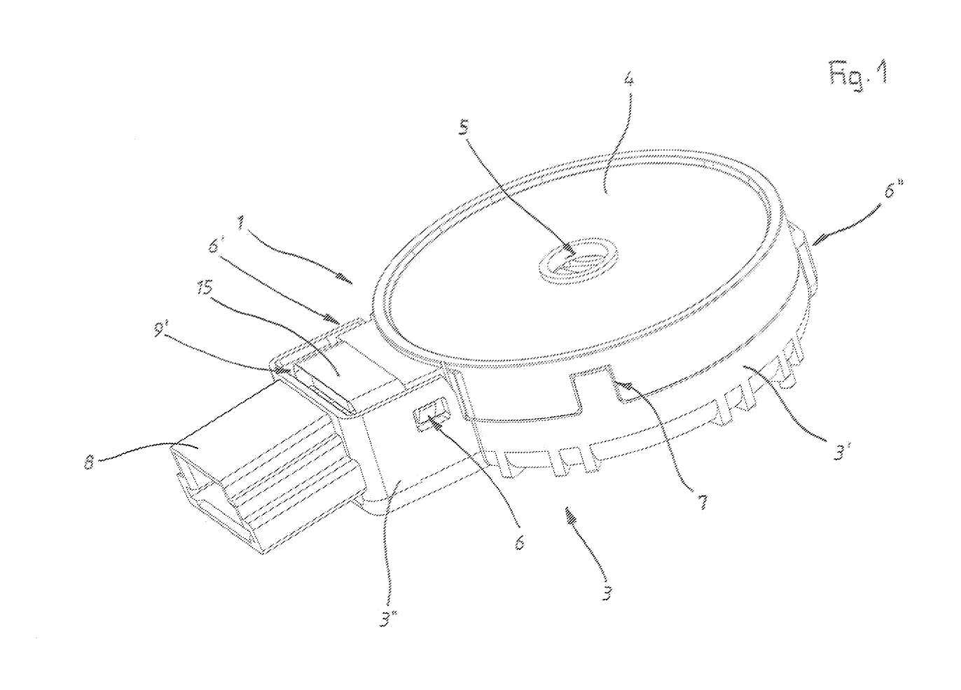

FIG. 1: A perspective view of a sensor arrangement with enclosed housing;

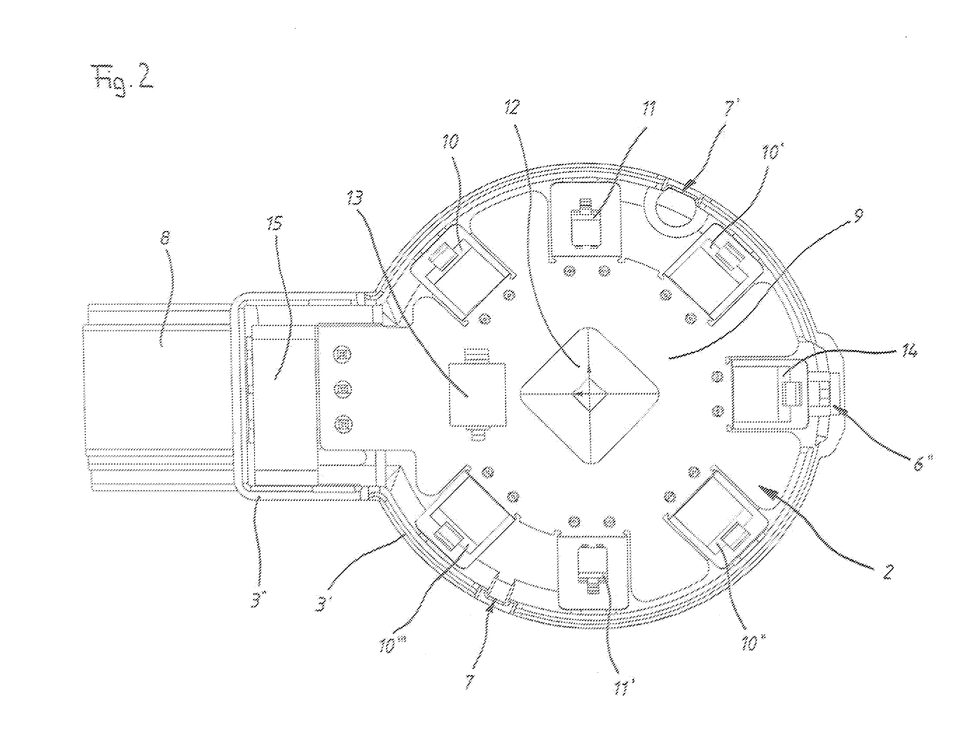

FIG. 2: A top view of the device according to the invention on FIG. 1 with opened housing, no cover, with exposed printed circuit board;

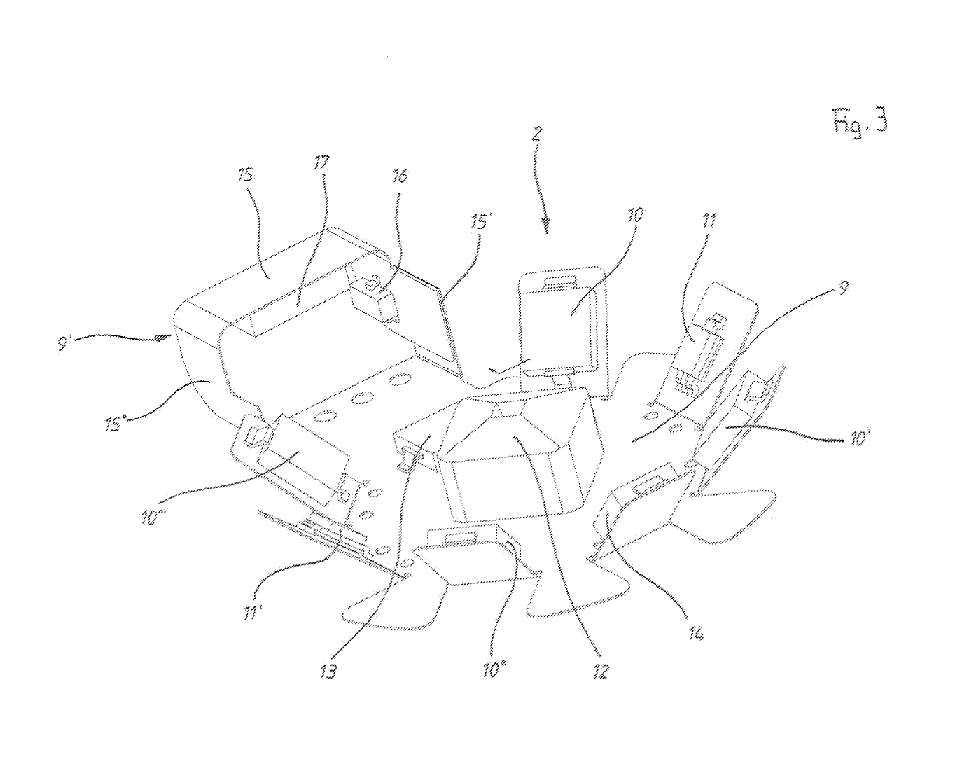

FIG. 3: A perspective view of a printed circuit board of the device on FIG. 1 and FIG. 2, with sensors arranged on the printed circuit board;

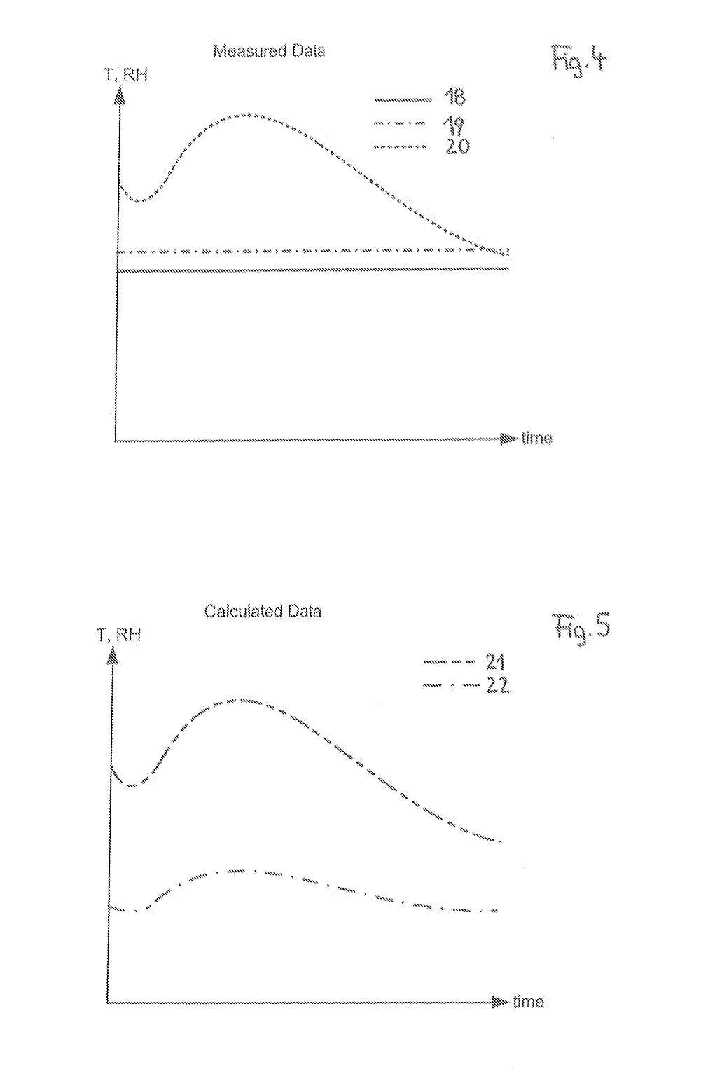

FIG. 4: A diagram of a measuring situation involving the acquired values for windowpane temperature, room temperature, and relative humidity of the windowpane, and

FIG. 5: A diagram with values for room air humidity and dew point as calculated using the diagram on FIG. 4.

A housing of a sensor arrangement 2 (FIG. 2) is marked 1. This housing 1 has a receiving section 3 and a cover 4, which are detachably joined together. The cover 4 is essentially circular, and the middle area of the formed circle exhibits an opening 5. The receiving section 3 exhibits a first circular receiving area 3′ and a second oblong connecting area 3″. Three snap-on connections 6, 6′, 6″ and two plug connectors 7, 7′ are provided for joining the receiving section 3 and cover 4. The receiving section exhibits three latching elements of the snap-on connections 6, 6′, 6″, of which two latching elements of the snap-on connections 6, 6′ are arranged at the oblong connecting area 3″ at the first end of the connecting area 3″ abutting the receiving area 3′, and a third latching element of the snap-on connection 6″ is situated at the circular receiving area 3′ on the side opposite the oblong connecting area 3″. In addition, the receptacles for the two plug connections 7, 7′ are arranged on the outer periphery of the circular receiving area 3′. Accordingly, the cover 4 exhibits detents and plug elements that correspond with the latching elements and receptacles.

The free second end of the oblong connecting area 3″ of the receiving section 3 also exhibits a plug connector 8 for transmitting data and attaching the sensor arrangement 2.

Inside the housing 1, a printed circuit board 9 is arranged on the receiving area 3′ of the receiving section 3, extending with a printed circuit board section 9′ into the oblong connecting area 3″ of the receiving section 3. The printed circuit board section 9′projects out of the housing with a partial area between the cover 4 and plug connector 8. In order to hold the printed circuit board 9 in position on the receiving section 3, the receiving section 3 exhibits pins corresponding with recesses in the printed circuit board 9.

FIG. 2 and FIG. 3 show the architecture of the printed circuit board 9 with the sensor arrangement 2. The printed circuit board 9 is circular in design, and exhibits a diameter slightly smaller than the internal diameter of the circular receiving area 3′ of the receiving section 3. The central region of the circular printed circuit board 9 exhibits a total of seven surfaces adjusted at an angle relative to the printed circuit board 9, which exhibit roughly the same distance from the central region. Optical elements are arranged on these surfaces.

Four of the seven optical elements on the adjusted surfaces of the printed circuit board 9 are receiving diodes 10, 10′, 10″, 10′″, which receive infrared radiation, wherein the receiving diodes 10, 10′, 10″, 10′″ are arranged around the central region of the printed circuit board, in particular offset at an angle of 90° relative to each other. The central region of the printed circuit board 9 exhibits a rain sensor, to which the receiving diodes 10, 10′, 10″, 10′″ and an emitting unit 12 are functionally allocated. The emitting unit 12 emits the infrared radiation, which for example reflected on a windowpane, which changes as a function of the wetting of the windowpane with water and will then receive from the receiving diodes 10, 10′, 10″, 10′″. A respective solar sensor 11, 11′ is arranged on the two remaining, oppositely adjusted surfaces of the printed circuit board 9, and can be used to acquire the direction of sunlight.

Also situated on the printed circuit board 9 between the emitting unit 12 and the connecting area 3″ of the receiving section 3 is an environmental light sensor 13, which acquires the brightness in its detection range. An advance light sensor 14 is arranged on the adjusted surface, which lies with the emitting unit 12 and environmental light sensor 13 on a straight line. This advance light sensor 14, which is designed as a switchable photodiode, and hence acquires radiation in at least two different spectral ranges, can detect the brightness in a predetermined distance to the sensor arrangement 2 on the one hand, and a reflecting light signal on the other. The opening angle for the coverage cone of the sensors is prescribed in particular by the dimensions of the opening 5 in the cover 4 and the position or arrangement of the respective light sensor 13, 14 relative to the opening 5.

The printed circuit board section 9′ is repeatedly angled by a respective 90° and projects through an opening with a contact surface 15 between the cover 4 and plug connector 8, which forms the partial region of the printed circuit board 9 visible on FIG. 1. Two surface pieces 15′, 15″ of the connecting section 9′ perpendicular to the contact surface 15 and printed circuit board 9 abut the contact surface 15, of which the surface piece 15′ joins the surface piece 15, which is embodied as the contact surface with the printed circuit board. The configuration of the circuit board section 9′ may be gleaned in particular from FIG. 3, wherein the two surface pieces 15′, 15″ are arranged parallel to the inner wall of the oblong connecting area 3″ of the receiving section 3.

Situated on the insides of the surfaces of the printed circuit board section 9′ are a temperature sensor 16 for acquiring the room and air temperature, and a combined humidity and temperature sensor 17 for acquiring a surface temperature as well as the room or air humidity. The combined temperature and humidity sensor 17 is here arranged on the contact surface piece 15 protruding out of the housing 1, while the temperature sensor 16 for acquiring the room or air temperature is arranged on the surface piece 15′ of the printed circuit board section 9′ situated perpendicular to the printed circuit board.

This embodiment of the sensor arrangement 2 is situated on the inside of the windshield of a vehicle, wherein the side with the cover 4 faces the windshield of the vehicle, and the oblong connecting area 3″ of the receiving section 3 is directed in the traveling direction. Hence, the detection range of the advance light sensor 14 exhibits an acquisition cone directed essentially in the traveling direction of the vehicle, while the environmental light sensor 13 exhibits a detection range with an essentially upwardly directed coverage cone. The data acquired by means of the environmental light sensor 13 and advance light sensor 14 can be used to adjust the headlight controller to the respective driving situation of the vehicle. Fog, snow or other environmental conditions that influence visibility can also be detected.

FIGS. 4 and 5 depict an exemplary measuring situation, wherein FIG. 4 shows the measured variables acquired with the temperature and humidity sensors 16, 17, and FIG. 5 shows the characteristic variables calculated from them, which are required, for example, to control an air-conditioning system in a room. Primarily the windowpane temperature 18, the room temperature 19 and relative humidity on the windowpane 20 are here measured. As may be gleaned from the diagram on FIG. 4, the windowpane temperature and room temperature remain nearly constant over the measured time span, while the measured relative humidity on the windowpane varies.

As evident from FIG. 5, the relative air humidity inside the room 21 as calculated from the acquired measured variables changes in this conjunction. The dew point 22 that changes over time in this connection is also calculated as a function of the calculated or determined room air humidity 21. Both curves here exhibit a similar progression, wherein the change in the curve progression for the dew point over the timeline is not subject to changes as intense as for the curve progression of the calculated, relative room humidity.

1. A device for acquiring predetermined state variables inside a room, with at least one temperature sensor and with a humidity sensor, at least regions of which are enclosed by a housing, wherein a first temperature sensor exhibits at least one contact surface for abutting against a perimeter surface bordering the room, and that at least one second temperature sensor is provided inside the housing for acquiring the room temperature,
wherein,
the contact surface is a surface piece of a printed circuit board section, which encompasses elastic characteristics, and that the printed circuit board section encompasses a plurality of surface pieces, which are angled relative to one another, wherein the temperature sensors are arranged at different surface pieces of the printed circuit board section.

2. The device according to claim 1, wherein the contact surface of the first temperature sensor protrudes over an opening on the outer contour of the housing.

3. The device according to claim 1, wherein
the housing exhibits passage openings for an air stream passed through the housing, which incorporate at least one of the temperature sensors.

4. The device according to claim 1, wherein the printed circuit board section is embodied as channel piece for the air stream, which is guided through the housing.

5. The device according to claim 1, wherein the housing exhibits passage openings for an air stream passed through the housing, which incorporate at least the humidity sensor.

6. The device according to claim 1, wherein at least one of the temperature sensors is an NTC resistor.

7. The device according to claim 1, wherein at least one of the temperature sensors is designed as a thermopile for contactless temperature measurement.

8. The device according to claim 1, wherein the housing accommodates at least one solar sensor.

9. The device according to claim 1, wherein at least one rain sensor is allocated to the temperature sensors.

10. A motor vehicle with at least one device for acquiring predetermined state variables, which is coupled with at least one control unit of an air-conditioning system for air-conditioning the interior of the vehicle, characterized in that the device is designed according to claim 1.

11. The motor vehicle according to claim 10, wherein the device is allocated to the front window of the vehicle.

12. The device for acquiring predetermined state variables inside a room according to claim 1, wherein the room is the interior of a motor vehicle.
